(19) United States
(12) Patent Application Publication
(10) Pub. No.: US 2008/0051202 A1
(43) Pub. Date: Feb. 28, 2008

(54) Console bezels

(75) Inventor: Robert R. Lube, Countryside, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Wells Gardner Electronics Corporation, McCook, IL (US)

(21) Appl. No.: 11/897,254

(22) Filed: Aug. 28, 2007

Related U.S. Application Data
(60) Provisional application No. 60/850,903, filed on Oct. 11, 2006.
(60) Provisional application No. 60/840,530, filed on Aug. 28, 2006.

(51) Int. Cl. A63F 13/00

(52) U.S. Cl. 463/46

(57) ABSTRACT

A gaming console bezel with protrusion to open the gaming console in order to access the internal components. The protrusion is positioned on the bezel for a user to grasp in order to easily open the bezel, including under the circumstance when the bezel is stuck. Bezels for flat panel displays in bar-top and table-top gaming consoles are also disclosed.

### CROSS-REFERENCES TO RELATED APPLICATIONS

This application claims priority to and benefit under 35 U.S.C. §119(e) to U.S. provisional application Ser. No. 60/840,530, filed Aug. 28, 2006 and U.S. provisional application Ser. No. 60/850,903, filed Oct. 11, 2006.

### FIELD OF THE INVENTION

The subject invention relates to bezels for mounting video displays, and to protrusions and bezels with protrusions for aiding in the opening of consoles.

### BACKGROUND OF THE INVENTION

A wide variety of video consoles exist that are designed to house or mount one or more video displays and further house and protect the electronics associated with the video display. Such consoles may be adapted for use in a wide variety of functions, such as an information kiosk, video game, or wager-based casino game. In general, video consoles commonly include a console housing to contain the console's electronics, and an opening in the console through which the video display is visible to a console user. If the console is a gaming console, it may further include features such as lights, buttons, a coin hopper, and bill validator, to name a few.

Gaming consoles have a wide variety of configurations, but generally fall into one of several categories. An “upright” gaming console configuration is typically free standing and configured to be positioned on the casino floor. Upright gaming console are generally tall and narrow, such that a user playing an upright console may do so from a standing or seated position in front of the gaming console. In general, upright gaming consoles include a base portion and top portion. The top portion includes the video display mounted within it, as well as input buttons and a bill acceptor. The base portion may also include a door to provide access to the internal components of the gaming console.

Other configurations of gaming consoles include the “slant-top” and “flat-top” gaming consoles. These consoles are typically configured to be positioned on a stand or cabinet, although free standing slant-top and flat-top gaming consoles exist, and are configured to accommodate a seated player in much the same fashion as a gaming table. Slant top and flat top gaming consoles differ primarily in the angle of the top portion, which in a slant-top console is inclined and in a flat-top console is horizontal. Flat top gaming consoles may include a free standing console, as well as a “bar top” gaming unit installed into a bar counter top.

FIG. 1 shows a slant top gaming console 10 according to the prior art. The console 10 includes a base portion 12, and a top portion 14 attached to the base portion 12. The top portion 14 may include as part of the top portion 14 a separate panel 16 that includes an opening through which a video display 20 is viewable. The panel 16 may be constructed of sheet metal, and typically includes hardware attached to the panel 16, such as buttons 24 and associated mounts and wiring. The video display 20, which may be a cathode ray tube or flat panel display, may be also mounted to the back of the panel 16. The console 10 may also include areas 22 adjacent the panel 16 for a player to place drinks, food and other items.

Included in the panel 16 is a generally annular bezel 26 mounted on top of and within the opening. The bezel 26 functions to facilitate a close mount of the panel 16 over the video display 20, and the bezel 26 may further include gasket material on an interior side so as to provide a relatively tight seal between the panel 16 and video display 20 to prevent liquids or debris that may fall onto the video display 20 from seeping into the console 10 and damaging the electronics therein.

The panel 16 is typically hingedly attached to the top portion 14 of the gaming console 10 at edge 30. In a closed position, the panel 16 typically sits on at least one spring-loaded arm (not shown) that is mounted within the top portion 14. Once the spring-loaded arm is activated by, for example, turning a key within a lock or pressing a button, the panel 16 is biased up from the top portion 14 a sufficient distance to create an opening such that a technician can insert a tool or fingers underneath the panel 16. The technician may then lift up on the panel 16 from the underside in order to bring the panel 16 to an open position, which allows access to the electronics within the console 10.

As previously described, the flat top and slant top gaming consoles often include areas 22 adjacent to the panel 16 on which users place food and drink. Consequently, food and drink is often spilled in the vicinity of the panel 16, and may infiltrate under the panel edge 28, under which is mounted the spring-loaded biasing arm. In such instances, the food or drink often causes the panel 16 to become adhered to the console top portion 14 such that the spring-loaded biasing arm is unable to provide sufficient force to dislodge the panel 16 from the console top portion 14. With no space to insert fingers or a tool to lift open the panel 16, technicians encounter significant difficulties in accessing the internal components of the gaming console 10. The method to overcome this impediment is usually the insertion of a lever, such as a flat-head screwdriver or the like, under the edge 28 to force the panel 16 away from the top portion 14 of the console 10. This method, while generally effective in releasing the panel 16 to allow it to open, tends to permanently and visibly mar the region of the gaming console 10 where the lever was inserted. The potential for damage increases commensurate with the amount of mass attached to the back of the panel 16, as the amount of torque required to dislodge the panel 16 is proportional to the mass of the panel 16.

There is a need, therefore, for a video console with a feature that allows it to be relatively easily opened, including under the circumstance when the bezel is stuck, in order to service the console. The present invention satisfies this demand.

### BRIEF SUMMARY OF THE INVENTION

Embodiments of the invention include a console for housing a video display and electronics associated with the video display where the console includes a console housing. The housing includes a housing top surface that defines an opening through the top surface that has a perimeter. A bezel having a bezel top surface is also included, and superimposed over the perimeter of the opening. A protrusion extends from the bezel top surface.

Other embodiments of the invention feature a portion of the housing top surface having the opening being pivotally attached to the console housing and positionable between an open position and a closed position. In addition, the protrusion has a surface adapted to receive the application of a lifting force applied to the protrusion to move the positionable portion of the housing top surface from the closed position to the open position. In certain embodiments, the surface of the protrusion adapted to receive the application of a lifting force is substantially planar. In other embodiments, the protrusion is positioned at an acute angle relative to the bezel top surface. In still other embodiments, the protrusion surface adapted to receive the application of a lifting force is concave and adapted to receive the application of a lifting force being positioned to receive one or more fingers on the surface. A plurality of protrusions may extend from the bezel top surface.

Certain embodiments of the invention feature a gaming console and bezel where the bezel top surface includes an outer perimeter and an inner perimeter. The bezel also includes a front wall attached to a first outer perimeter edge; a rear wall in opposed relationship to the front wall attached to a second outer perimeter edge; and opposed side walls attached to respective opposed third and fourth outer perimeter edges. The side walls are each adjacent to the front wall and the rear wall, and each of the front wall, rear wall, and side walls are further attached to the bezel top surface at respective top edges, and attached to the console housing proximate the housing top surface opening at respective bottom edges. Other embodiments include the bezel of claim having a plurality of protrusions that each includes a surface adapted to receive the application of a lifting force applied to the protrusion. Certain other embodiments include the protrusion of the bezel having a substantially planar surface adapted to receive the application of a lifting force applied to the surface. And in other embodiments, the plurality of protrusion surfaces adapted to receive the application of a lifting force applied to each protrusion is concave and each is positioned to receive one or more fingers thereon. The protrusion may be alternately attached to a flange that is attached to a lower edge of the bezel front wall, at a flange edge that is in opposed relationship to the flange edge that is attached to the bezel front wall.

Other embodiments of the invention disclose a console for housing a video display and electronics associated with the video display having a console housing. The console housing has a housing top surface that includes an opening through the housing top surface. The opening has a perimeter. At least a portion of the housing top surface is pivotally attached to the console housing, and positionable between an open position and a closed position. A video display is mounted within the console and positioned proximate the opening. A protrusion having a surface adapted to receive the application of a lifting force applied to the protrusion extends from the portion of the housing top surface that is positionable between an open position and a closed position.

Still other embodiments disclose abezel for mounting a flat panel video display above a mounting surface. The bezel includes a bezel top surface, the bezel top surface having a generally annular configuration having an inner border defining an opening through which a video display may be viewed, the bezel top surface further including an outer border defining a front edge, back edge, and two lateral side edges, wherein the front edge and back edge are in opposed relationship and the two lateral side edges are in opposed relationship and adjacent to the front edge and back edge; a back panel attached to the top surface back edge, the back panel having a pair of opposed side edges and a bottom edge; a front panel attached to the top surface front edge, the front panel having a shorter length than the back panel, the front panel having a pair of opposed side edges and a bottom edge, wherein the bezel top surface is in an angled relationship to a plane intersecting the back panel bottom edge and the front panel bottom edge; and a pair of lateral panels attached to respective opposed bezel top surface lateral side edges, each lateral panel having a pair of opposed side edges and a bottom edge, each lateral panel being positioned adjacent the front panel and the back panel and attached to respective front panel and back panel side edges along adjacent lateral panel side edges.

The bezel may also include a flat panel display disposed within and mounted to the bezel. In certain embodiments, a plane intersects the bottom edges of the bezel back panel, the front panel, and each side panel. The bezel top surface may also form an angle with the plane intersecting the back panel bottom edge and the front panel bottom edge of between 1 and 90 degrees. In other embodiments, the bezel top surface may form an angle with the plane intersecting the back panel bottom edge and the front panel bottom edge of between 8 and 30 degrees.

The bezel of claim may also include a mounting flange attached to at least one of the bottom edges of the back panel, the front panel, and each side panel, the mounting flange adapted to engage a surface for attachment of the bezel. A console may be mounted to the mounting flange, wherein the console is configured to house electronics adapted to operatively attach to a video display. In certain embodiments, the console is a bar-top or table-top console.

### BRIEF DESCRIPTION OF THE DRAWINGS

FIG. 1 is a front perspective view of a gaming console according to the prior art;

FIG. 2 illustrates a front perspective view of a gaming console according to one embodiment of the invention;

FIG. 3A illustrates a front perspective view of a bezel with protrusion according to one embodiment of the invention;

FIG. 3B illustrates a side view of the bezel depicted in FIG. 3A;

FIG. 4 illustrates a side view of the gaming console shown in FIG. 2 depicting movement of the bezel with protrusion according to one embodiment of the invention.

FIG. 5A illustrates a perspective view of another embodiment of a gaming console according to the present invention; and

FIG. 5B illustrates a side view of the bezel depicted in FIG. 5A and 5C.

FIG. 5C illustrates a perspective view of the bezel depicted in FIGS. 5A and 5B;

FIG. 6 illustrates a perspective view of a handle assembly according to the present invention;

FIG. 7 illustrates a perspective view of another handle assembly according to the present invention;

FIG. 8 illustrates a perspective view of a gaming console and handle assembly according to the present invention; and

FIG. 9 illustrates a perspective view of a bezel according to the present invention.

### DETAILED DESCRIPTION OF THE INVENTION

While the present invention, in one embodiment, is particularly well suited for use with a slant-top, flat-top, and bar-top gaming consoles or assemblies as described herein, the system may be used with a variety of other video consoles, such as video kiosks and video games, with similar benefits.

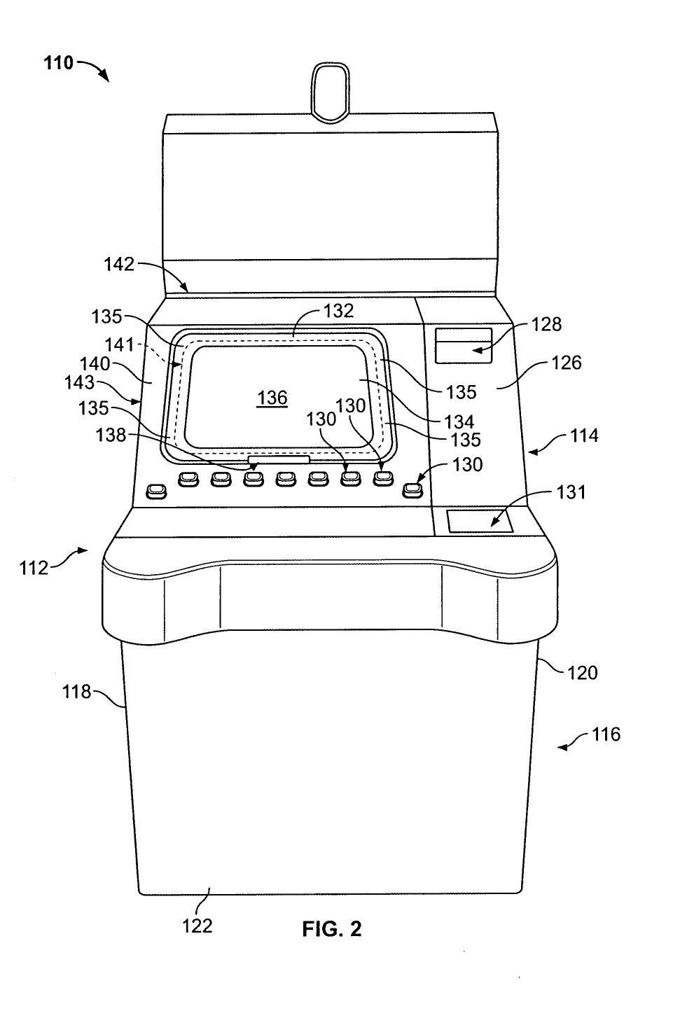

FIG. 2 shows a gaming console 110 including a housing 112. In one embodiment, the housing 112 includes a top portion 114 and a base portion 116. The base portion 116 is defined by a first side 118, a second side 120, a front wall 122 and rear wall (not shown). The first side 118 is opposed from the second side 120 and the front wall 122 and rear wall extend between the first side 118 and second side 120. The sides 118, 120 and front 122 and rear walls define a perimeter of the base portion 116 of the housing 110.

The first side 118, second side 120, front wall 122 and rear wall are constructed of any suitable material, such as metal, plastic, or wood. The sides 118, 120 and front 122 and rear walls may be assembled as separate pieces, or formed as a unitary construction.

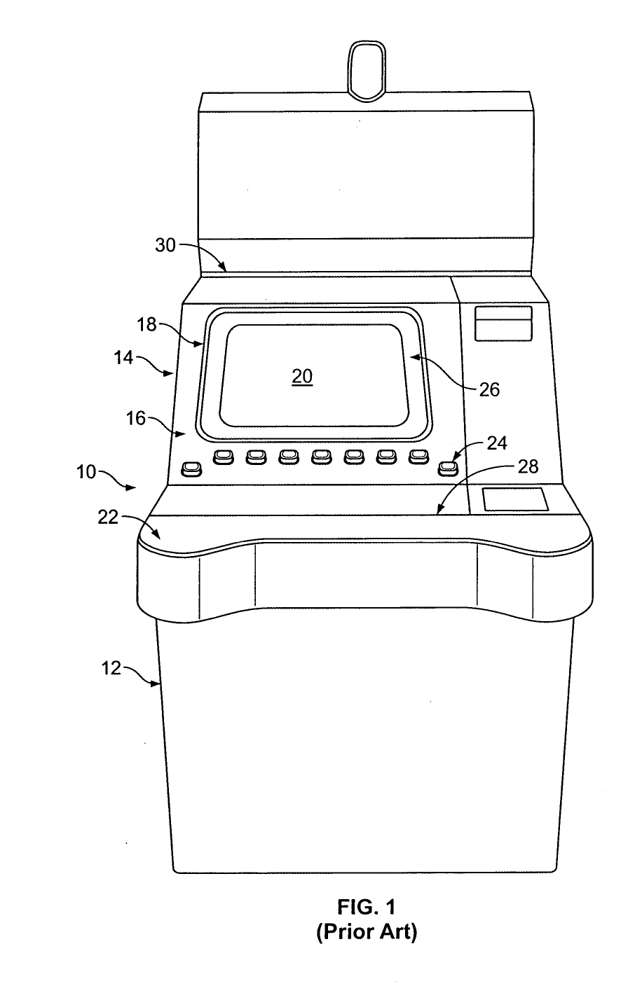

The housing 112 includes the internal electronic components of the gaming console 110. The internal components may include a central processing unit (CPU), motherboard, memory, power supply, cooling mechanism, hard drive, video card, sound card, speakers, and network card, for example. The device illustrated in FIG. 1 has a slant-top surface, but embodiments of the present invention are adaptable to any type of video console surface, including a horizontal surface such as that found in flat-top gaming consoles. The top portion 114 may further include a bill acceptor 128, input buttons 130, coin hopper 131, and bezel 132.

The top portion 114 includes a top surface 126 that may also include panel 140. The bezel 132 defines an opening through which the display 136 is viewed. The panel 140 is hingedly attached to the top portion 114 of the console 110 at a top edge 142. The console may optionally include one or more spring-loaded arms under the panel 140 which, when activated by a user, may bias the panel 140 upwards. In other embodiments, the spring-loaded arms are eliminated.

The display 136 is typically mounted behind the bezel 132, and may be attached to the rear of the bezel 132 or to a bracket or shelf (not shown) within the console 110. Systems and methods of mounting flat panel displays in consoles are disclosed in United States patent application publication number 20060187624, which is incorporated herein by reference. In addition to securing the display 136 in certain embodiments, it is further contemplated that embodiments of the bezel 132 may support a panel (not shown) of transparent material, such as glass or plastic and the like about the bezel 132 inner perimeter, and which is mounted in front of the video display 136 to protect the video display 136 from damage.

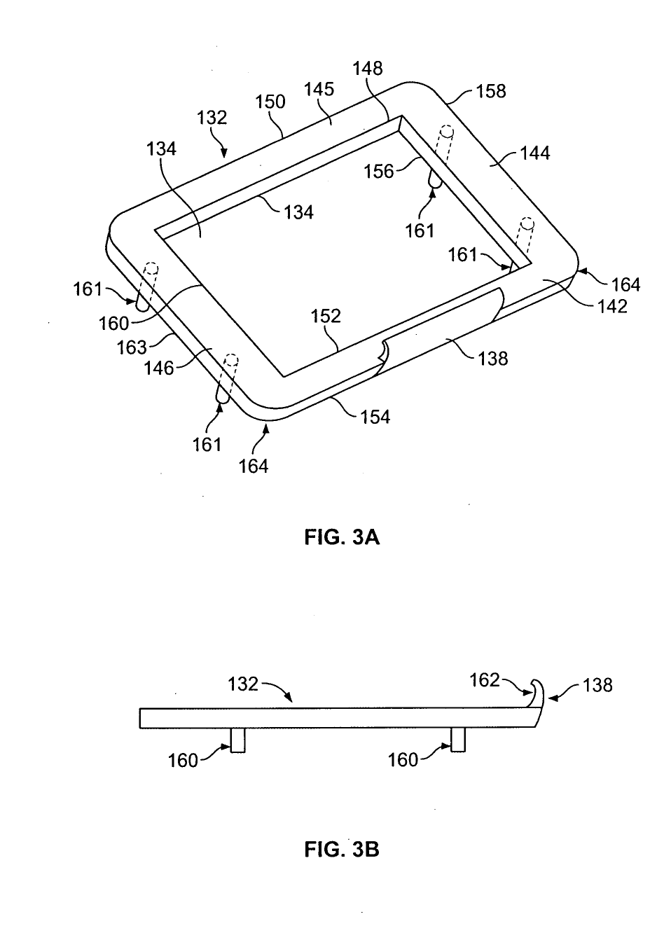

As best shown in FIGS. 3A and 3B, an embodiment of the bezel 132 is generally annular in shape with an overall rectangular configuration of its inner perimeter 134 and outer perimeter 154. Pegs 161 are attached to the rear surface of the bezel 132 and extend perpendicular to the bezel rear surface, and pegs 161 are preferably tapped. As shown in FIG. 2, pegs 161 mount through holes 135 on panel 140, which are preferably adjacent to the opening in the panel 140, partially over which the bezel 132 is mounted. Fasteners are threaded into the pegs 161, thereby securing the bezel 132 to the panel 140.

The bezel 132 is preferably unitary, and includes a top member 145, bottom member 142, first side member 144 and second side member 146. The top member 145 is opposed from the bottom member 142 and the first side member 144 and second side member 146 extend between the top member 145 and bottom member 142. The top member 145 includes edge 148 and edge 150. The bottom member 142 includes edge 152 and edge 154. The first side member 144 includes edge 156 and edge 158. The second side member 146 includes edge 160 and edge 163. Edges 148, 152, 156 and 160 form the inside perimeter of the bezel 132 and define the opening 134 through which the video display (not shown) is viewed. Edge 150, 154, 158 and 162 form the outside perimeter of the bezel 132. Although the bezel 132, as shown in FIG. 2, is of rectangular shape, it is contemplated that the bezel 132 can be of any suitable size or shape, including, for example, square or circular. In one embodiment, the bezel 132 is constructed of metal, but it is contemplated that the bezel 132 can be constructed of any material of sufficient rigidity including, for example, plastic or composite materials.

The bezel 132 further includes a protrusion 138. In a preferred embodiment, the protrusion 138 extends upwardly from a bottom edge 154 of the bezel 132 in a generally perpendicular direction, although it is contemplated that the protrusion 138 can be positioned along any edge 148, 150, 152, 154, 156, 158, 160, 163, or positioned on any member 145, 142, 144, 146 of the bezel 132. In a preferred embodiment, the protrusion 138 has a surface 162 having an indented or concave configuration along at least a portion of surface 162 such that a user can place his or her fingers on the surface 162 and lift up on the protrusion 138 to impart a lifting force to the bezel 132 and panel 140 to which it is attached. In other embodiments, a plurality of protrusions may be employed and may have different configurations, such as a knob, handle, or ridge. In addition, the protrusion 138 may be further placed at, for example, one or both of the lower corners 164 of the bezel 132, which may be less visually distracting to players.

Protrusion 138 may further be positioned such that surface 162 and surface 142 form an acute angle. Alternately, protrusion 138 may be positioned generally perpendicularly with respect to surface 142. The protrusion 138 may be either integral to the bezel 132, or formed of a separate piece that is secured to the bezel 132 by any suitable means, such as welding, gluing, or fastening. In addition, protrusion 138 may be constructed of the same or a different material than the bezel 138. Referring to FIG. 2, other embodiments of the invention include a protrusion, such as protrusion 138 shown in FIGS. 3A-3B, mounted or integral with the panel 140 at any suitable location, such as, for example, panel region 143, or adjacent the bezel 132, or any other panel 140 location deemed suitable for attaching or integrating a protrusion 138 for allowing a user to apply a lifting force for lifting the panel 140 out of the plane in which it is mounted during normal operation of the gaming console 110.

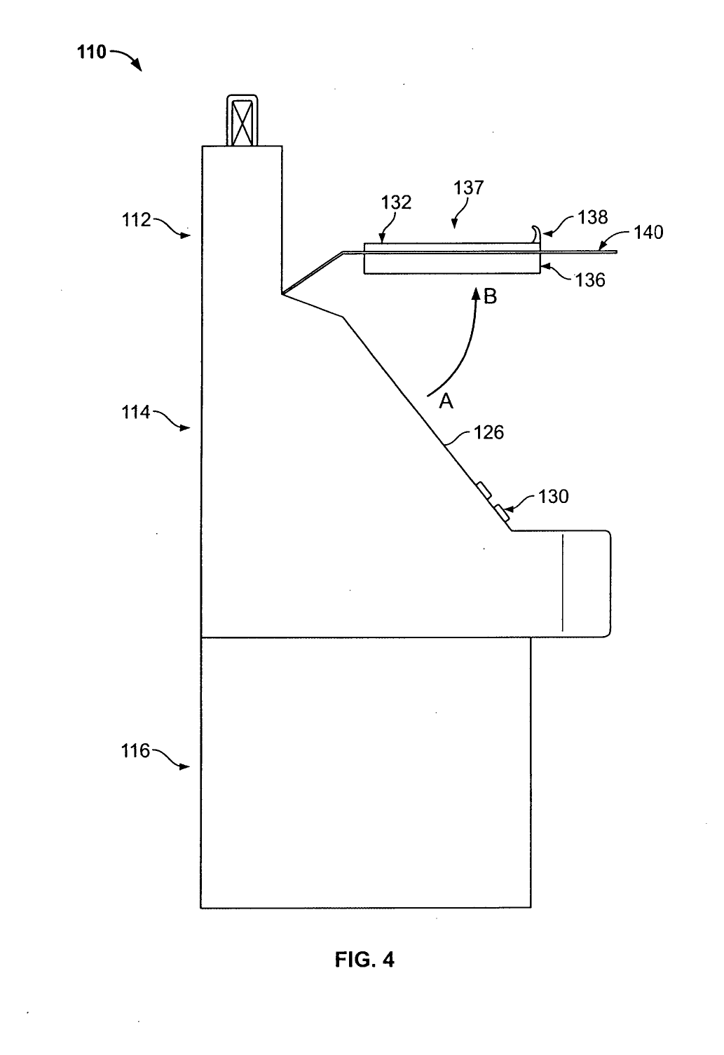

FIG. 4 illustrates a side view of the gaming console 110 shown in FIG. 1 depicting movement of the panel 140 and bezel 132 with protrusion 138 according to one embodiment of the invention. In a first position A, the panel 140, bezel 132 and video display 136 assembly 137 is positioned generally flush with the console top surface 126. The assembly 137 is lifted via a lifting force imparted to protrusion 138 to a second position B, away from the top surface 126. In position B, the internal components of the gaming console may be accessed.

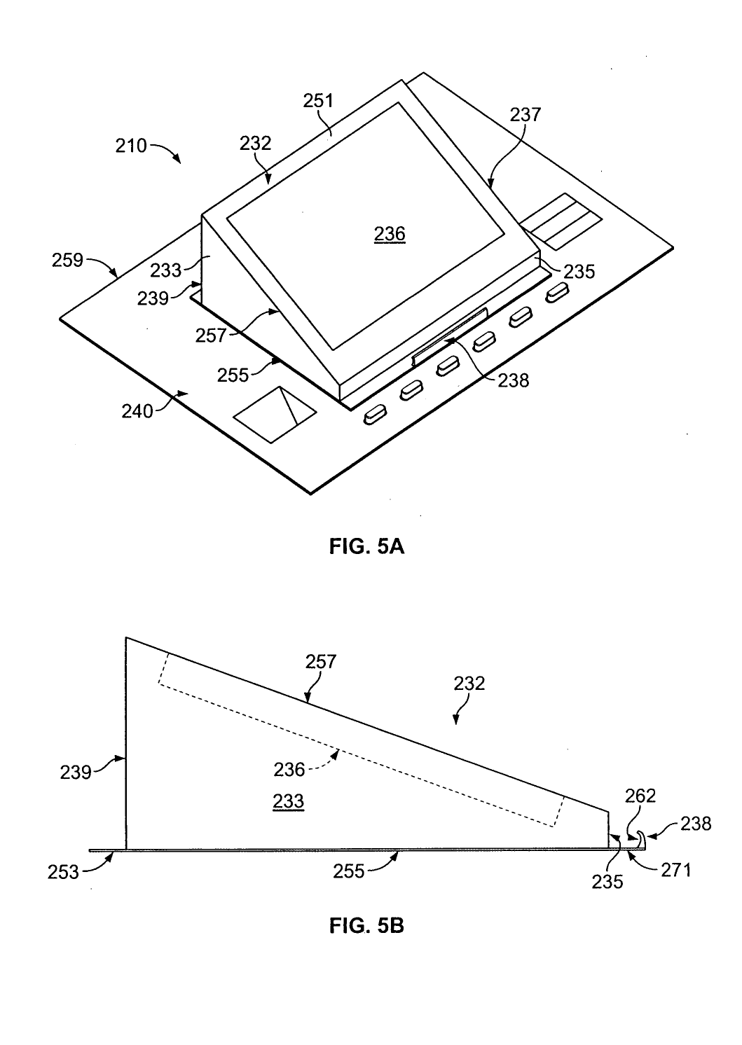

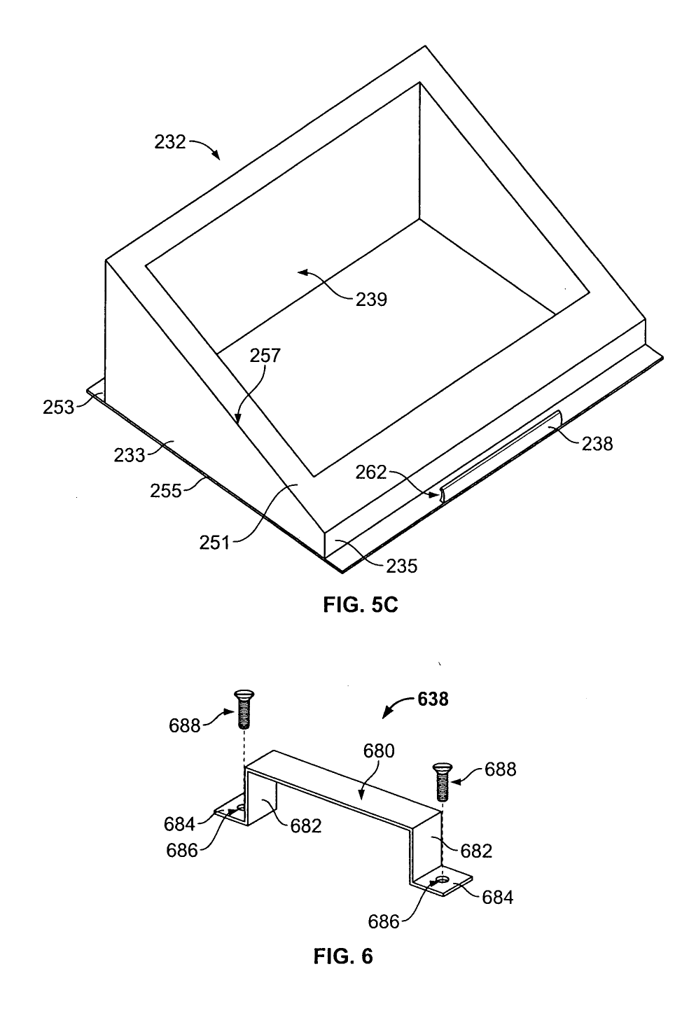

As shown in FIGS. 5A, 5B, and 5C, another embodiment of the invention includes a bezel 232 adapted for use in a “bar-top” gaming console 210. Bar-top gaming consoles, as the name implies, are often installed in the counter top 237 of a bar in a lounge setting. The bar-top console 210 differs from the previously-described gaming consoles primarily in that it is not a freestanding console, and is instead integrated into a larger installation, which is typically a bar 237 in a lounge. Otherwise, the bar-top gaming console 210 includes the same electronics and interactive buttons as does the other consoles described herein. Another difference is that the bar-top console 210 is more susceptible to infiltration from food and drink since it is designed to be installed where users will be eating and drinking while playing the gaming console 210.

In one embodiment, bezel 232 is configured to be installed within a bar-top gaming console 210 to mount a video display 236 within the bezel 232 in a position to provide a desirable viewing angle to a user seated at the bar 237. The bezel 232 includes a top surface 251 that defines a generally annular configuration having an opening through which a video display 236 is visible. In a preferred embodiment, the video display 236 is a flat panel type display, which is preferably positioned adjacent the rear surface of the bezel top surface 251.

At the outer peripheral edge of the bezel top surface 251, sides 233, 235, 237, 239 project generally perpendicularly downwardly. Preferably, at least one flange 253 is attached to the bottom edge of at least one side 233, 235, 237, 239, through which fasteners attach the bezel 232 to the panel 240, which in turn is preferably hingedly attached to the bar top 237 at edge 259. The bezel 232 preferably includes a rear lateral side 239 that is longer than the front lateral side 235 such that the top surface 251, which spans between the sides 239, 235, is sloped with respect to the bezel lower edge 255. Sides 233, 237 are shaped to span between the space created by the rear wall 239, top surface 251, front wall 235, and horizontal plane spanning the lower edges of the front 235 and rear 239 walls.

In certain embodiments, front wall 235 may be eliminated. In such embodiments, a lower front edge of top surface 251 may form the lower front edge of the bezel 232, and preferably lies along a plane even with bezel lower edge 255.

Mainly because an LCD-type flat panel display 220 requires a viewing angle of between 0 and 90 degrees, and preferably between 8 and 30 degrees, depending on the specific display used, a display (such as display 226) is preferably positioned by bezel 232 at a steeper angle than would be a CRT display, and at a level above the bar top 212, which facilitates viewing by a user. As such, a bar-top console 210 or table top console having an LCD or other flat panel display 236 mounted therein may include bezel 232 configured to hold the flat panel display 236 at the desired angle and at the desired elevation relative to the bar top 237 or table top.

In certain embodiments, a protrusion 238 may be attached to the bezel 232 proximate the front wall 235. In a preferred embodiment, the protrusion 238 is attached to a flange 271, which extends from the lower edge of the front wall 235 such that the protrusion 238 is spaced away from the front wall thereby providing sufficient space for a user's fingers to be inserted against the inner surface 262 of the protrusion 238 to provide a lifting force to the protrusion 238. As with the protrusion configuration described with respect to FIGS. 2 and 3A-B, the protrusion 238 configuration may be any shape sufficient to allow a user to apply a lifting force to facilitate the lifting of the bezel 232, together with an attached panel 240 if so installed, away from the plane in which the bezel 232 is mounted during operation. In other embodiments, the protrusion 238 or a plurality of protrusions may be mounted to other regions of the bezel 238, such as lower edge 255 or upper edge 257 of the sides 233, 237. Other embodiments of the invention include a protrusion 238 mounted or integral with the panel 240 at any suitable location, such as, for example, the panel 240 edge adjacent lower bezel edge 255.

Accessing the console interior in a bar top unit is achieved in much the same way as the method described with respect to the slant top unit depicted in FIG. 2. Typically, spring-loaded arms are mounted below the panel 240, and are released by a key or other mechanism to bias the panel 240 upwards a sufficient distance to allow a technician to reach under panel 240 and lift up the panel 240. When these spring-loaded arms malfunction or the panel 240 becomes stuck to bar top 237, a technician may apply a lifting force to protrusion 238 to lift the bezel 232, or bezel 232 and panel 240 assembly, upwards to access the interior of the gaming console 210. Alternately, the spring-loaded arms may be eliminated from the assembly and the bezel 232, or bezel 232 and panel 240 assembly, may be lifted solely by a lifting force applied to protrusion 238.

Other embodiments of the invention may include a selectively attachable protrusion, which may be particularly useful in retrofitting existing gaming consoles. As shown in FIG. 6, the protrusion may be in the form of a handle 638. Handle 638 may include flanges 684 with holes 686 for attachment to a console panel with fasteners such as screws 688. Attached to flanges 684 may be vertical members 682 between which is attached horizontal member 680. Once attached to a console panel (not shown), a lifting force may be applied to the underside of horizontal member 680 to lift the panel.

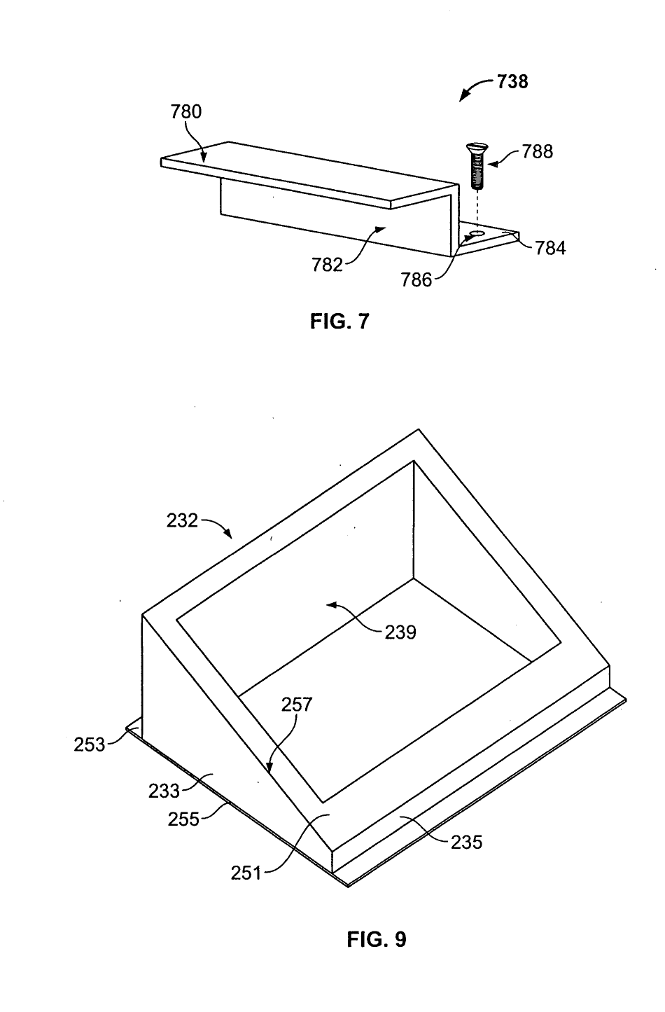

Another embodiment of a selectively attachable handle is shown in FIG. 7. Handle 738 may include flange 784 that preferably includes holes 786 for attachment to a console panel with fasteners such as screws 788. Vertical member 788 is attached to flange 784 and extends generally perpendicularly from flange 784. Horizontal member 780 is attached to vertical member 782. Once attached to a console panel (not shown), a lifting force may be applied to the underside of horizontal member 780 to lift the panel.

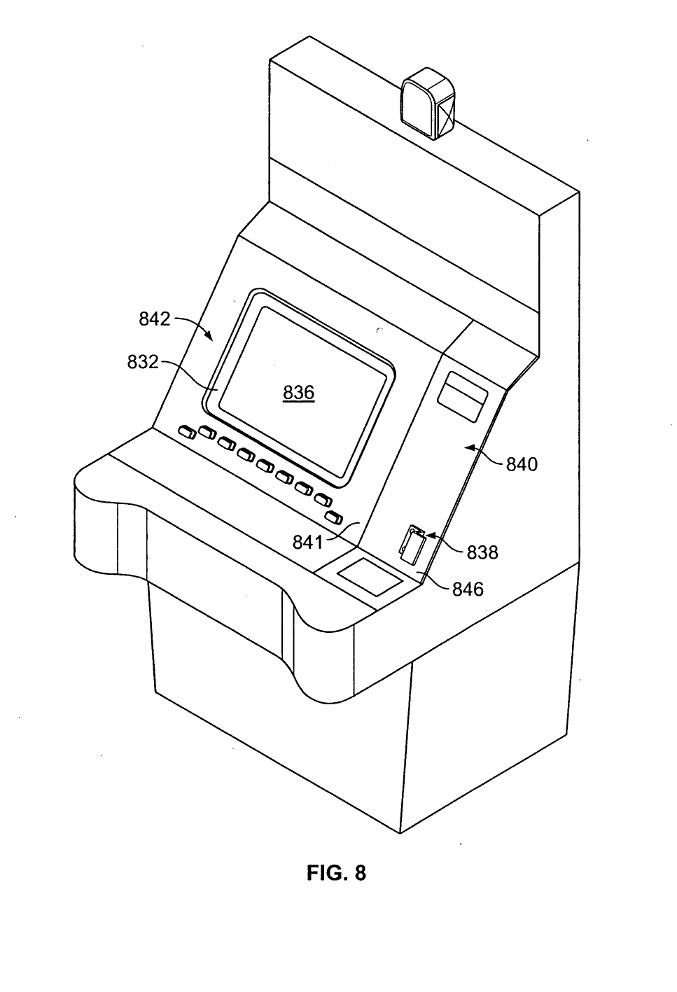

FIG. 8 depicts a console to which one or more selectively attachable handles may be attached to console top panel 846. Handles, such as handle 838, may be attached at any suitable location. In a preferred embodiment, handle 838 is attached to one or more locations 840, 841, 842. Selectively attachable handle, such as handle 838, may be attached in any manner sufficient to secure the handle to the panel 846. Such attachment means may include, for example, fasteners, welds, adhesives, and the like.

The above description of illustrated embodiments of the invention is not intended to be exhaustive or to limit the invention to the precise form disclosed. While specific embodiments of, and examples of, the invention are described in the foregoing for illustrative purposes, various equivalent modifications are possible within the scope of the invention, as those skilled in the relevant art will realize. Moreover, the various embodiments described above can be combined to provide further embodiments. Accordingly, the invention is not limited by the disclosure, but instead the scope of the invention is to be determined entirely by the following claims.

What is claimed is:

1. A console for housing a video display and electronics associated with the video display, comprising:
a console housing, the housing including a housing top surface, the housing top surface defining an opening therethrough, the opening having a perimeter;
a bezel, the bezel including a bezel top surface, the bezel being superimposed over the perimeter of the opening; and
a protrusion extending from the bezel top surface.

2. The gaming console of claim 1, wherein at least a portion of the housing top surface is pivotally attached to the console housing, the portion of the housing top surface being positionable between an open position and a closed position, the portion of the top surface including the opening in the housing top surface; and
the protrusion includes a surface adapted to receive the application of a lifting force applied to the protrusion to move the portion of the housing top surface from the closed position to the open position.

3. The gaming console of claim 2, wherein the surface adapted to receive the application of a lifting force is substantially planar.

4. The gaming console of claim 3, wherein the protrusion is positioned at an acute angle relative to the bezel top surface.

5. The protrusion of claim 3, wherein the surface adapted to receive the application of a lifting force is concave, the surface adapted to receive the application of a lifting force being positioned to receive one or more fingers thereon.

6. The gaming console of claim 1, further including a plurality of protrusions extending from the bezel top surface.

7. The gaming console of claim 1, wherein the bezel top surface includes an outer perimeter and an inner perimeter, the bezel further including:
a front wall attached to a first outer perimeter edge;
a rear wall attached to a second outer perimeter edge, the first and second outer perimeter edges being in opposed relationship; and
opposed side walls attached to respective opposed third and fourth outer perimeter edges, the side walls each being adjacent to the front wall and the rear wall, and wherein each of the front wall, rear wall, and side walls are attached to the bezel top surface at respective top edges and attached to the console housing proximate the housing top surface opening at respective bottom edges.

8. The bezel of claim 7, further including a plurality of protrusions, the protrusions each including a surface adapted to receive the application of a lifting force applied to the protrusion.

9. The bezel of claim 7, wherein the protrusion surface adapted to receive the application of a lifting force applied to the protrusion is substantially planar.

10. The bezel of claim 7, wherein the protrusion surface adapted to receive the application of a lifting force applied to the protrusion is concave, each protrusion surfaces being adapted to receive the application of a lifting force being positioned to receive one or more fingers thereon.

11. The bezel of claim 7, further including a flange attached to the lower edge of the front wall, the flange including a first flange edge and an opposed second flange edge, the flange being attached to the lower edge of the front wall at the flange first edge, and wherein the protrusion is attached to the second flange edge.

12. A console for housing a video display and electronics associated with the video display, comprising:
a console housing, the housing including a housing top surface, the housing top surface defining an opening therethrough, the opening having a perimeter, and wherein at least a portion of the housing top surface is pivotally attached to the console housing, the portion of the housing top surface being positionable between an open position and a closed position;
a video display mounted within the console, the video display being positioned proximate the opening; and
a protrusion extending from the portion of the housing top surface that is positionable between an open position and a closed position, the protrusion including a surface adapted to receive the application of a lifting force applied to the protrusion.

13. A bezel for mounting a flat panel video display above a mounting surface, comprising:
a bezel top surface, the bezel top surface having a generally annular configuration having an inner border defining an opening through which a video display may be viewed, the bezel top surface further including an outer border defining a front edge, back edge, and two lateral side edges, wherein the front edge and back edge are in opposed relationship and the two lateral side edges are in opposed relationship and adjacent to the front edge and back edge;
a back panel attached to the top surface back edge, the back panel having a pair of opposed side edges and a bottom edge;
a front panel attached to the top surface front edge, the front panel having a shorter length than the back panel, the front panel having a pair of opposed side edges and a bottom edge, wherein the bezel top surface is in an angled relationship to a plane intersecting the back panel bottom edge and the front panel bottom edge; and
a pair of lateral panels attached to respective opposed bezel top surface lateral side edges, each lateral panel having a pair of opposed side edges and a bottom edge, each lateral panel being positioned adjacent the front panel and the back panel and attached to respective front panel and back panel side edges along adjacent lateral panel side edges.

14. The bezel of claim 13, further comprising a flat panel display disposed within and mounted to the bezel.

15. The bezel of claim 13, wherein the plane intersects the bottom edges of the back panel, the front panel, and each side panel.

16. The bezel of claim 13, wherein the bezel top surface forms an angle with the plane intersecting the back panel bottom edge and the front panel bottom edge of between 1 and 90 degrees.

17. The bezel of claim 13, wherein the bezel top surface forms an angle with the plane intersecting the back panel bottom edge and the front panel bottom edge of between 8 and 30 degrees.

18. The bezel of claim 13, further comprising a mounting flange attached to at least one of the bottom edges of the back panel, the front panel, and each side panel, the mounting flange adapted to engage a surface for attachment of the bezel.

19. The bezel of claim 18, further comprising a console mounted to the mounting flange, wherein the console is configured to house electronics adapted to operatively attach to a video display.

20. The bezel of claim 19, wherein the console is a bar-top or table-top console.
